(19) United States
(12) Patent Application Publication
(10) Pub. No.: US 2022/0316632 A1
(43) Pub. Date: Oct. 6, 2022

(54) PRESSURE BALANCING MECHANISM FOR A CONNECTOR

(71) Applicant: PETROTECHNOLOGIES, INC., Broussard, LA (US)

(72) Inventor: David Levy, Broussard, LA (US)

(21) Appl. No.: 17/846,995

(22) Filed: Jun. 22, 2022

Related U.S. Application Data
(63) Continuation-in-part of application No. 16/101,067, filed on Aug. 10, 2018.

(51) Int. Cl. F16L 19/07

(52) U.S. Cl. CPC F16L 19/07

(57) ABSTRACT

A pressure balancing apparatus can have a compression collar to mate with a component comprising a seal, and a gripper to anchor to a tube and the compression collar. The compression collar is used to apply an axial force to the tube to relieve shear stress on proximate seals. The method can include mating a compression collar to a component comprising a seal, anchoring a gripper to a tube, mating the gripper to the compression collar, and using the compression collar to apply an axial force to the tube.

### FIELD

The present embodiments relate to a pressure balancing mechanism and a method of use.

### BACKGROUND

Often connectors are used for sections of tube used for fluid flow. These connectors can make use of seals to prevent fluid leakage. Based upon the application, tubes can be subject to back pressure or vacuum from a process or system to which the tube is connected.

Pressure imbalance can result in shear stresses applied to seals and require large and costly seals for many applications.

Therefore, a need exists for a mechanism which can pressure balance a tube against process and/or system pressure, allowing smaller seals to be used.

The present embodiments meet this need.

### BRIEF DESCRIPTION OF THE DRAWINGS

The detailed description will be better understood in conjunction with the accompanying drawings as follows:

FIG. 1 depicts a perspective view of an embodiment of a prior art high pressure energizable connector.

FIG. 2A depicts a side view of the prior art high pressure energizable connector of FIG. 1.

FIG. 2B depicts a cross-sectional view of the prior art high pressure energizable connector of FIG. 2A along line 1-1.

FIG. 3 depicts a cross-sectional view of an embodiment of the pressure balancing mechanism.

FIG. 4A depicts the connector of FIG. 3 showing force being applied in an axial direction.

FIG. 4B depicts the connect of FIG. 3 showing force being applied in the opposite axial direction.

The present embodiments are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about” means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The present embodiments relate to a pressure balancing mechanism for a tube. The pressure balancer can reduce or eliminate shear stresses on seals within sealed components in contact with the tube due to process or system pressure on the tube.

The tube can be any conduit used for the flow of fluids and/or slurries. Tubulars used in wellbores, large sections of pipe, plastic tubing, and the like are all usable for the purposes of this disclosure.

The pressure balancer can have a compression collar for mating with a component comprising a seal and a gripper for anchoring to a tube.

The compression collar preferably mates with the component comprising a seal and the gripper with a threadable engagement. However, any mechanism, such as a ratchetable connection, which can axially position the gripper in relation to the component comprising a seal can be used.

The gripper can utilize any means known to persons having ordinary skill in the art for anchoring to the tube. The embodiment shown utilizes a compressible and deformable ferrule. The ferrule can deform into the tube when depressed which anchors the gripper to the tube.

The present embodiments also relate to a method for pressure balancing a tube component comprising a seal.

The method can include the steps of: mating a compression collar to a sealed component, anchoring a gripper to a tube, mating the gripper with the compression collar, and rotating the compression collar to apply an axial force to the tube. A threaded connection between the compression collar and the gripper, as well as a threaded connection between the compression collar and the sealed component cause the sealed component and the gripper to move axially with respect to one another when the compression collar is rotated.

In embodiments, the method can include the steps of:

Sliding a compression collar onto a tube and engaging a component comprising a seal with the compression collar. It is preferred that the component comprising a seal and compression collar are threadably engaged, so as to allow easy adjustment of axial distance between the two. Rotation of the compression collar would cause an axial displacement.

The method can then include the step of sliding a gripper into the tube and engaging the gripper with the compression collar. It is preferred that the gripper and compression collar are threadably engaged, so as to allow easy adjustment of axial distance between the two. Rotation of the compression collar would cause an axial displacement.

The method can then include the step of gripping the tube. In embodiments, this can be accomplished by sliding a ferrule over the tube inside the gripper and then compressing the ferrule, wherein compressing the ferrule deforms the ferrule and anchors it to the tube. The tube, therefore, moves with the gripper and any axial force applied to the gripper is translated to the tube.

The compression collar can then be used to apply an axial force to the tube. When threadably engaged, this can be accomplished by rotating the compression collar. Persons having ordinary skill in the art can determine the magnitude and direction of the force applied based upon whether the tube is subject to vacuum or positive pressure in the specific application.

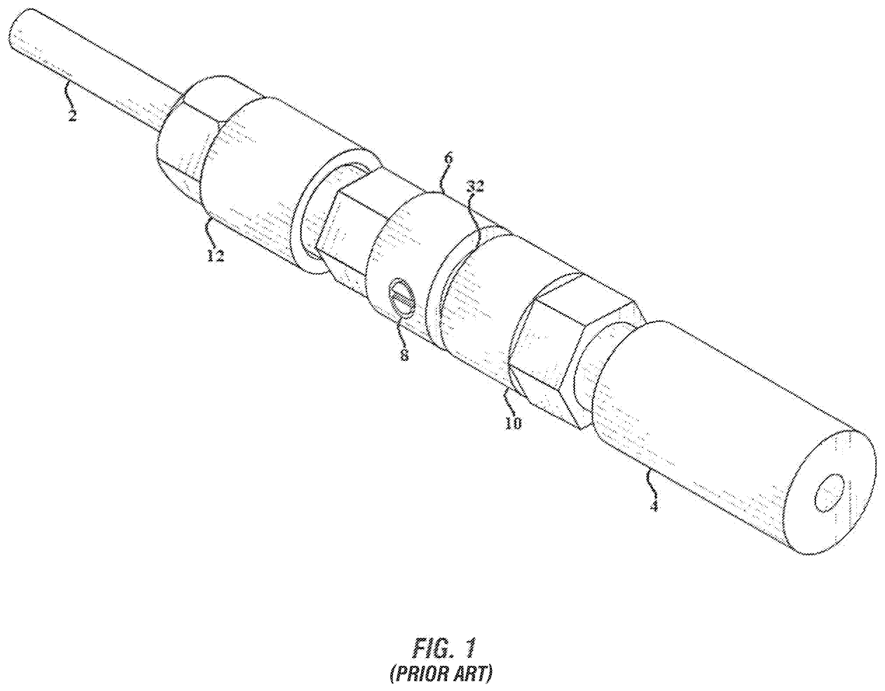

Referring now to the Figures, FIG. 1 is a perspective view of an embodiment of a prior art high pressure energizable connector. The present disclosure can be coupled with any sealed component (i.e., a connector such as this) to relieve shear strain on the seals.

Tube 2 is shown inserted into an inverted jam nut 12. Inverted jam nut 12 can be any kind of nut or connector able to be disposed about the tube 2 and threadably engaged to adjacent connectors.

Inverted jam nut 12 is shown threadably engaged to a first nipple 6. First nipple 6 can have a test port 8 disposed therein. A second nipple 10 can be adjustably and threadably engaged with first nipple 6, forming an adjustable threaded engagement 32. Second nipple 10 is depicted threadably engaged with a female profile 4.

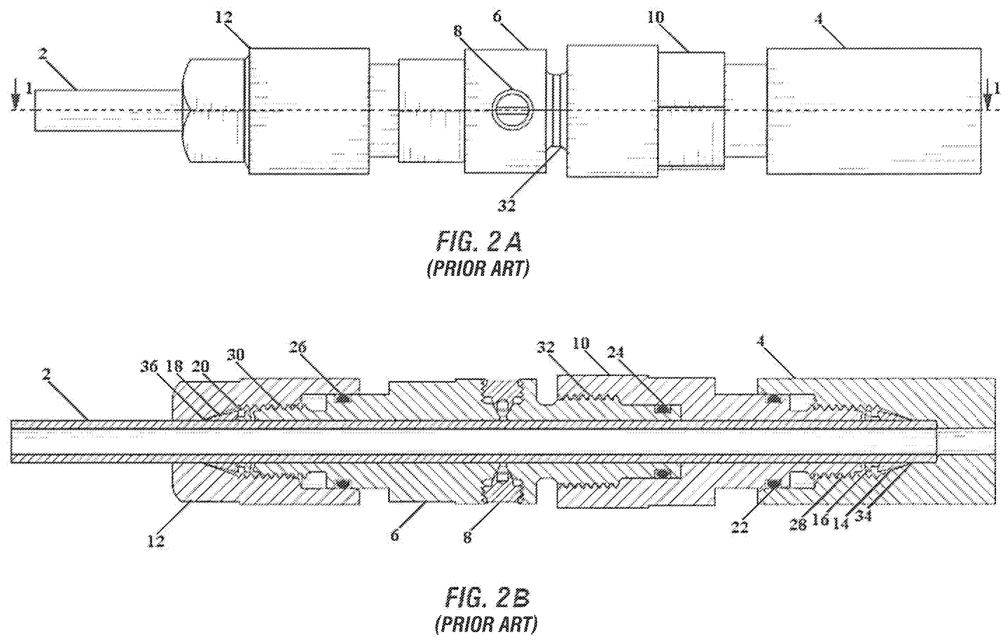

FIG. 2A is a side view of a prior art high pressure energizable connector.

Tube 2 is shown inserted into the inverted jam nut 12. Inverted jam nut 12 is threadably engaged with the first nipple 6 having a test port 8. First nipple 6 is adjustably and threadably engaged with the second nipple 10, forming an adjustable threaded engagement 32. Second nipple 10 is threadably engaged with the female profile 4.

FIG. 2B depicts a cross section of the prior art high pressure energizable connector of FIG. 2A along line 1-1.

Tube 2 is depicted inserted into the inverted jam nut 12. Inverted jam nut 12 is shown threadably engaged with the first nipple 6, forming a second threaded engagement 30. First nipple 6 can have a test port 8.

A second front ferrule 18 and a second rear ferrule 20 are disposed around the tube 2 between the inverted jam nut 12 and the first nipple 6. A secondary seal 36 is formed by compressing the second rear ferrule 20 and the second front ferrule 18 into the inverted jam nut 12 and the tube 2 using a pressure applied through a test port 8.

First nipple 6 is also shown having a third seal 26, which can be an O-ring or a similar kind of seal, disposed between the first nipple 6 and the inverted jam nut 12.

First nipple 6 is depicted adjustably and threadably engaged with the second nipple 10, forming an adjustable threaded engagement 32. It is contemplated that the adjustable threaded engagement 32 can be tightened or loosened as needed to compensate for slack in the tube 2 after applying a pressure through the test port 8.

First nipple 6 is shown having a second seal 24, which can be an O-ring or similar kind of seal, disposed between the first nipple 6 and the second nipple 10. Second nipple 10 is shown having a first seal 22, which can also be an O-ring or a similar kind of seal, disposed between the second nipple 10 and a female profile 4.

Female profile 4 is shown disposed about the tube 2 and threadably engaged with the second nipple 10, forming a first threaded engagement 28. A first front ferrule 14 and a first rear ferrule 16 are disposed around the tube 2 between the second nipple 10 and the female profile 4. A primary seal 34 is formed by compressing the first rear ferrule 16 and the first front ferrule 14 into the female profile 4 and the tube 2 using a pressure applied through test port 8.

As can be seen from both prior art designs, the seals formed by the ferrules will be subject to shear stress based upon process pressure of the specific application applying axial force to the tube.

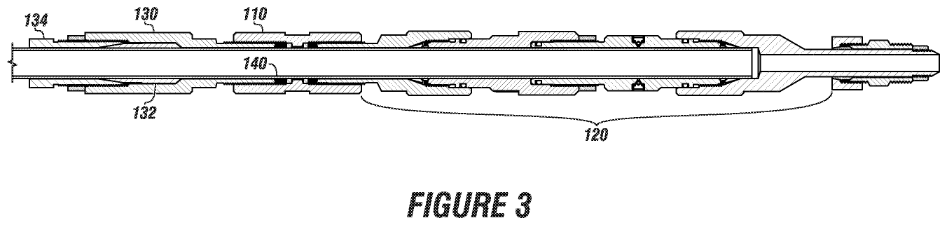

The present disclosure, shown in FIG. 3 allows for seals that need not be subject to the full shear stresses of the specific application to be utilized for because of pressure balancing. Whether the tube is subject to vacuum or positive pressure, the present disclosure can reduce or eliminate such stress on the seals.

FIG. 3 depicts a cross-sectional view of an embodiment of the pressure balancing mechanism.

A compression collar 110 is shown threadably engaged with a sealed component 120, such as the connector shown in FIGS. 1, 2A and 2B. A gripper 130 is in mechanical communication with compression collar 110. Ferrule 132 can be used to anchor the gripper to a tube 140. In the embodiment shown, a nut 134 is used to deform the ferrule 132 and anchor it to the tube 140

As the compression collar 110 is rotated, the threaded engagement of compression collar 110 with sealed component 120 and gripper 130 causes compression collar 110 and gripper 130 to be axially displaced with respect to one another. As the gripper 130 is anchored to tube 140 with ferrule 132, this thereby causes an axial force to be applied to the tube, allowing for pressure balancing as desired. The axial force can be toward or away from a sealed component 120 as needed depending upon the direction that compression collar 110 is rotated.

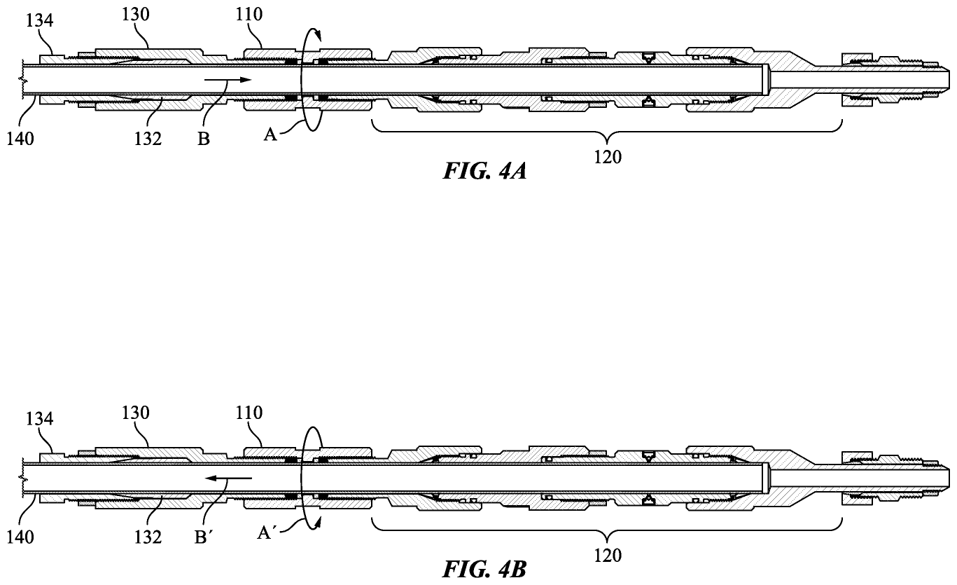

FIG. 4A depicts the connector of FIG. 3 showing force being applied in an axial direction. This Figure shows when compression collar 110 is rotated in one direction, shown here as A, this causes gripper 130 to move axially in direction B. Because tube 140 is anchored to gripper 130 via ferrule 132, force is applied to the tube 140 in the same axial direction B.

FIG. 4B depicts the connect of FIG. 3 showing force being applied in the opposite axial direction. This Figure shows when compression collar 110 is rotated in the other direction, shown here as A′, this causes gripper 130 to move axially in direction B′. Because tube 140 is anchored to gripper 130 via ferrule 132, force is applied to the tube 140 in the same axial direction B′.

While the present disclosure emphasizes the presented embodiments and Figures, it should be understood that within the scope of the appended claims, the disclosure might be embodied other than as specifically described herein.

What is claimed is:

1. A pressure balancer for a tube comprising:
a compression collar for threadably mating with a component comprising a seal;
a gripper for anchoring to the tube and threadably mating with the compression collar;
a ferrule disposed over the tube, wherein the ferrule anchors the gripper to the tube when compressed; and
wherein rotating the compression collar causes the component comprising a seal and the gripper to be axially displaced with respect to one another, thereby applying an axial force to the tube due to the gripper being anchored to the tube.

2. The pressure balancer of claim 1, further comprising a nut for compressing the ferrule and anchoring the gripper to the tube.

3. The pressure balancer of claim 1, wherein rotating the compression collar in one direction applies the axial force to the tube toward the component comprising the seal and rotating the compression collar in the other direction applies the axial force to the tube away from the component comprising the seal.

4. A method for making a pressure balanced connection with a component comprising a seal, wherein the method comprises the steps of:
threadably mating a compression collar to the sealed component;
anchoring a gripper to a tube proximate the compression collar;
threadably mating the gripper with the compression collar; and
rotating the compression collar to displace the sealed component with respect to the gripper, thereby applying an axial force to the tube.

5. The method of claim 4, wherein anchoring the gripper to the tube comprises the step of deforming a gripper ferrule.

6. A method for making a pressure balanced connection with a component comprising a seal, wherein the method comprises the steps of:
sliding a compression collar onto a tube;
threadably engaging the component comprising the seal with the compression collar;
sliding a gripper into the tube;
threadably engaging the gripper with the compression collar;
gripping the tube with the gripper; and
rotating the compression collar to displace the sealed component with respect to the gripper, thereby applying an axial force to the tube.

7. The method of claim 6, wherein gripping the tube comprises:
sliding a ferrule over the tube inside the gripper; and
compressing the ferrule.

8. The method of claim 7, wherein compressing the ferrule deforms the ferrule and anchors it to the tube.

9. The method of claim 7, wherein the ferrule is compressed with a jam nut.
